(19) United States
(12) Patent Application Publication
(10) Pub. No.: US 2016/0140463 A1
(43) Pub. Date: May 19, 2016

(54) DECISION SUPPORT FOR COMPENSATION PLANNING

(71) Applicant: International Business Machines Corporation, Armonk, NY (US)

(72) Inventors: Raphael Ezry, New York, NY (US); Munish Goyal, Haryana (IN); Raymond Ngai, Tsim Sha Tsui (HK)

(21) Appl. No.: 14/543,957

(22) Filed: Nov. 18, 2014

(51) Int. Cl. G06Q 10/06; G06Q 40/00

(52) U.S. Cl. CPC G06Q 10/067; G06Q 10/0639; G06Q 40/00

(57) ABSTRACT

Aspects model a set of different employee compensation adjustment factors from a locally weighted linear regression function of employee data. Retention probabilities are generated for retaining each of the employees, and employee retention costs modeled as a function of historic employee wage data, the modeled set of employee compensation adjustment factors and the retention probabilities. Costs are modeled for replacing employees as a function of the employee wage data and the historic market data, and revenues are modeled for employee productivity as a function of the retention probabilities and the historic business performance and strategy data. The modeled employee compensation adjustment factors are iteratively optimized to maximize a profit objective value determined as a function of the modeled costs for replacing employees and employee productivity revenues.

### BACKGROUND

Enterprise employees may define a workforce with diverse skills dispersed across multiple geographic boundaries. Comprehensive workforce management of compensation levels across diverse and dispersed workforces is challenging. For example, each of a variety of local labor markets may be impacted differently by highly dynamic local market conditions, relative to different regions within a common nation, state, county, etc., as well as relative to regions within other countries. Current macroeconomic conditions may have uncertain and highly variable effects within any given region relative to another region.

Providing comprehensive solutions for anticipated workforce management needs for a given enterprise may require significant resources. The resource expenditure may consume assets that would be better spent in other areas, particularly when an anticipated demand does not materialize. Conversely, an under-commitment of resources may lead to losses of realizable revenue when the comprehensive solutions are inadequate for the actual workforce management needs. Reactive strategies often fail to solve problems arising from under commitment of resources, particularly under volatile market conditions, as there may not be enough time to implement solutions globally.

### BRIEF SUMMARY

In one aspect of the present invention, a method for automated adaptation of employee compensation values to analytical models includes modeling a set of different employee compensation adjustment factors from a locally weighted linear regression function of historic employee data generated over a historic time period of an enterprise. Retention probabilities are generated for retaining each of the employees as a function of historic employee data, historic market data, historic business performance data and historic business strategy data. Total employee retention costs are modeled as a function of employee wage data of the historic employee data, the modeled set of different employee compensation adjustment factors and the generated retention probabilities. Costs are modeled for replacing employees as a function of the employee wage data and the historic market data, and revenues modeled for employee productivity generated by employees as a function of the generated retention probabilities, the historic business performance data and the business strategy data. The modeled employee compensation adjustment factors are iteratively optimized to maximize a profit objective value determined as a function of the modeled costs for replacing employees and the modeled employee productivity revenues.

In another aspect, a method provides a service for automated adaptation of employee compensation values to analytical models. Said method includes integrating computer readable program code into a computer readable tangible storage medium in communication with a processor of a hardware controller of a first device. Computer readable program code is embodied on the computer readable tangible storage medium and includes instructions that, when executed by the processor via a computer readable memory, cause the processor to model a set of different employee compensation adjustment factors from a locally weighted linear regression function of historic employee data generated over a historic time period of an enterprise. Retention probabilities are generated for retaining each of the employees as a function of historic employee data, historic market data, historic business performance data and historic business strategy data. Total employee retention costs are modeled as a function of employee wage data of the historic employee data, the modeled set of different employee compensation adjustment factors and the generated retention probabilities. Costs are modeled for replacing employees as a function of the employee wage data and the historic market data, and revenues modeled for employee productivity generated by employees as a function of the generated retention probabilities, the historic business performance data and the business strategy data. The modeled employee compensation adjustment factors are iteratively optimized to maximize a profit objective value determined as a function of the modeled costs for replacing employees and the modeled employee productivity revenues.

In another aspect, a system has a processor in communication with a computer readable memory and a computer readable storage medium with program instructions. The processor, when executing program instructions stored on the computer readable storage medium, models a set of different employee compensation adjustment factors from a locally weighted linear regression function of historic employee data generated over a historic time period for employees of an enterprise. Retention probabilities are generated for retaining each of the employees as a function of historic employee data, historic market data, historic business performance data and historic business strategy data. Total employee retention costs are modeled as a function of employee wage data of the historic employee data, the modeled set of different employee compensation adjustment factors and the generated retention probabilities. Costs are modeled for replacing employees as a function of the employee wage data and the historic market data, and revenues modeled for employee productivity generated by employees as a function of the generated retention probabilities, the historic business performance data and the business strategy data. The modeled employee compensation adjustment factors are iteratively optimized to maximize a profit objective value determined as a function of the modeled costs for replacing employees and the modeled employee productivity revenues.

In another aspect, a computer program product has a computer readable storage medium with computer readable program code embodied therewith, the computer readable program code including instructions that, when executed by a computer processor, cause the computer processor to model a set of different employee compensation adjustment factors from a locally weighted linear regression function of historic employee data generated over a historic time period for employees of an enterprise. Retention probabilities are generated for retaining each of the employees as a function of historic employee data, historic market data, historic business performance data and historic business strategy data. Total employee retention costs are modeled as a function of employee wage data of the historic employee data, the modeled set of different employee compensation adjustment factors and the generated retention probabilities. Costs are modeled for replacing employees as a function of the employee wage data and the historic market data, and revenues modeled for employee productivity generated by employees as a function of the generated retention probabilities, the historic business performance data and the business strategy data. The modeled employee compensation adjustment factors are iteratively optimized to maximize a profit objective value determined as a function of the modeled costs for replacing employees and the modeled employee productivity revenues.

### BRIEF DESCRIPTION OF THE SEVERAL VIEWS OF THE DRAWINGS

These and other features of embodiments of the present invention will be more readily understood from the following detailed description of the various aspects of the invention taken in conjunction with the accompanying drawings in which:

FIG. 1 depicts a cloud computing node according to an embodiment of the present invention.

FIG. 2 depicts a cloud computing environment according to an embodiment of the present invention.

FIG. 3 depicts abstraction model layers according to an embodiment of the present invention.

FIG. 4 is a flow chart illustration of a method or process according to the present invention for automated adaptation of employee compensation values to analytical models.

FIG. 5 is a flow chart illustration of an implementation of the process, system or method of FIG. 4.

### DETAILED DESCRIPTION

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

It is understood in advance that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly release to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure comprising a network of interconnected nodes.

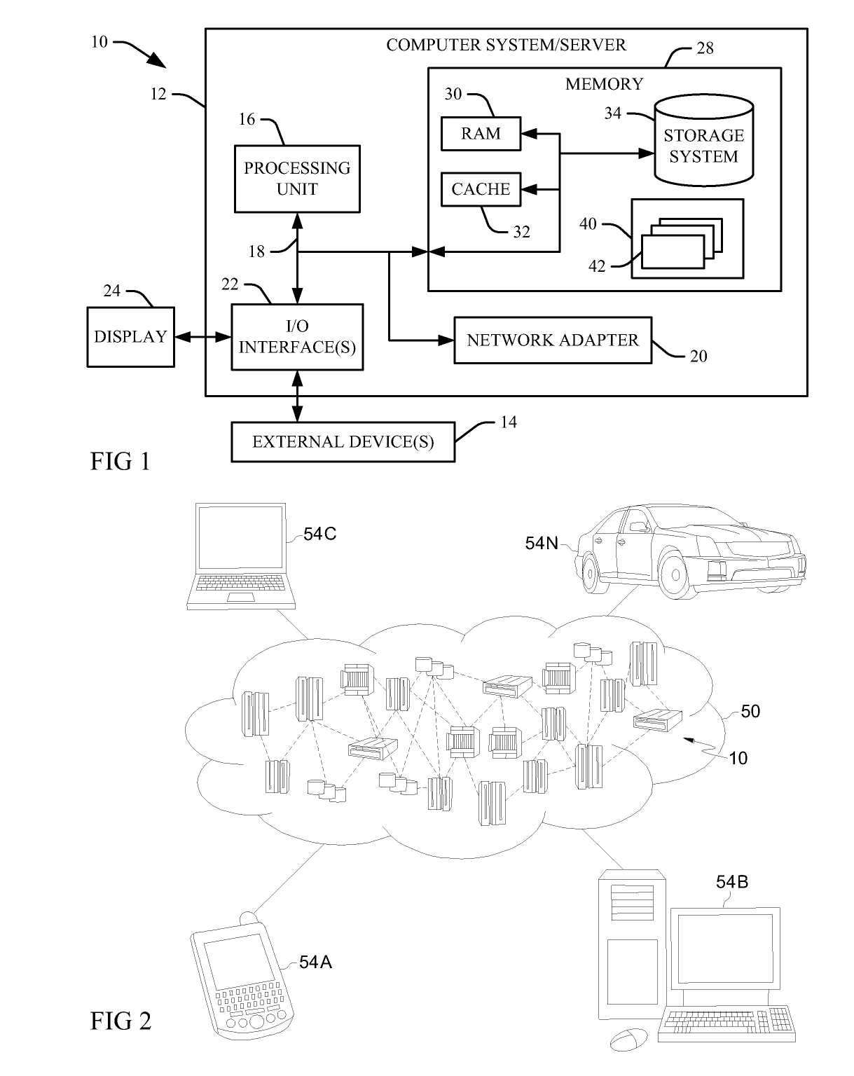

Referring now to FIG. 1, a schematic of an example of a cloud computing node is shown. Cloud computing node 10 is only one example of a suitable cloud computing node and is not intended to suggest any limitation as to the scope of use or functionality of embodiments of the invention described herein. Regardless, cloud computing node 10 is capable of being implemented and/or performing any of the functionality set forth hereinabove.

In cloud computing node 10 there is a computer system/server 12, which is operational with numerous other general purpose or special purpose computing system environments or configurations. Examples of well-known computing systems, environments, and/or configurations that may be suitable for use with computer system/server 12 include, but are not limited to, personal computer systems, server computer systems, thin clients, thick clients, hand-held or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system/server 12 may be described in the general context of computer system-executable instructions, such as program modules, being executed by a computer system. Generally, program modules may include routines, programs, objects, components, logic, data structures, and so on that perform particular tasks or implement particular abstract data types. Computer system/server 12 may be practiced in distributed cloud computing environments where tasks are performed by remote processing devices that are linked through a communications network. In a distributed cloud computing environment, program modules may be located in both local and remote computer system storage media including memory storage devices.

As shown in FIG. 1, computer system/server 12 in cloud computing node 10 is shown in the form of a general-purpose computing device. The components of computer system/server 12 may include, but are not limited to, one or more processors or processing units 16, a system memory 28, and a bus 18 that couples various system components including system memory 28 to processor 16.

Bus 18 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus.

Computer system/server 12 typically includes a variety of computer system readable media. Such media may be any available media that is accessible by computer system/server 12, and it includes both volatile and non-volatile media, removable and non-removable media.

System memory 28 can include computer system readable media in the form of volatile memory, such as random access memory (RAM) 30 and/or cache memory 32. Computer system/server 12 may further include other removable/non-removable, volatile/non-volatile computer system storage media. By way of example only, storage system 34 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media, can be provided. In such instances, each can be connected to bus 18 by one or more data media interfaces. As will be further depicted and described below, memory 28 may include at least one program product having a set (e.g., at least one) of program modules that are configured to carry out the functions of embodiments of the invention.

Program/utility 40, having a set (at least one) of program modules 42, may be stored in memory 28 by way of a non-limiting example, as well as an operating system, one or more application programs, other program modules, and program data. Each of the operating system, one or more application programs, other program modules, and program data or some combination thereof, may include an implementation of a networking environment. Program modules 42 generally carry out the functions and/or methodologies of embodiments of the invention as described herein.

Computer system/server 12 may also communicate with one or more external devices 14 such as a keyboard, a pointing device, a display 24, etc.; one or more devices that enable a user to interact with computer system/server 12; and/or any devices (e.g., network card, modem, etc.) that enable computer system/server 12 to communicate with one or more other computing devices. Such communication can occur via Input/Output (I/O) interfaces 22. Still yet, computer system/server 12 can communicate with one or more networks such as a local area network (LAN), a general wide area network (WAN), and/or a public network (e.g., the Internet) via network adapter 20. As depicted, network adapter 20 communicates with the other components of computer system/server 12 via bus 18. It should be understood that, although not shown, other hardware and/or software components could be used in conjunction with computer system/server 12. Examples include, but are not limited to: microcode, device drivers, redundant processing units, external disk drive arrays, RAID systems, tape drives, and data archival storage systems, etc.

Referring now to FIG. 2, illustrative cloud computing environment 50 is depicted. As shown, cloud computing environment 50 comprises one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 2 are intended to be illustrative only and that computing nodes 10 and cloud computing environment 50 can communicate with any type of computerized device over any type of network and/or network addressable connection (e.g., using a web browser).

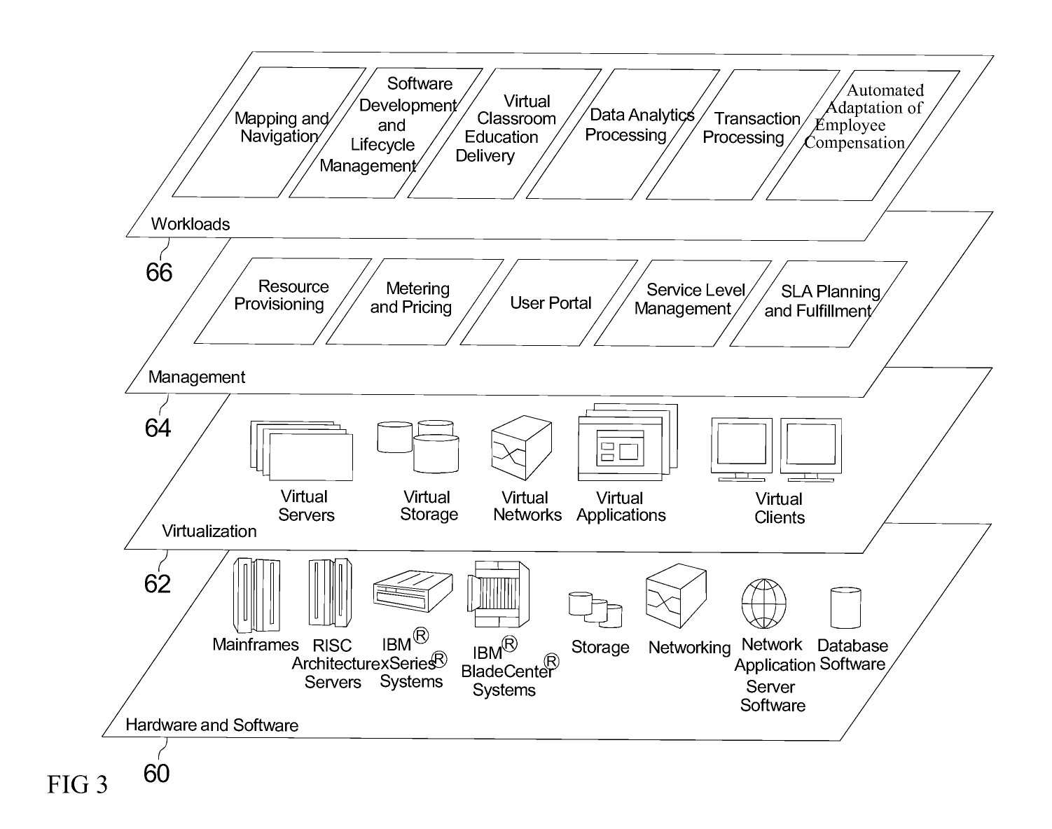

Referring now to FIG. 3, a set of functional abstraction layers provided by cloud computing environment 50 (FIG. 2) is shown. It should be understood in advance that the components, layers, and functions shown in FIG. 3 are intended to be illustrative only and embodiments of the invention are not limited thereto. As depicted, the following layers and corresponding functions are provided:

Hardware and software layer 60 includes hardware and software components. Examples of hardware components include mainframes, in one example IBM® zSeries® systems; RISC (Reduced Instruction Set Computer) architecture based servers, in one example IBM pSeries® systems; IBM xSeries® systems; IBM BladeCenter® systems; storage devices; networks and networking components. Examples of software components include network application server software, in one example IBM WebSphere® application server software; and database software, in one example IBM DB2® database software. (IBM, zSeries, pSeries, xSeries, BladeCenter, WebSphere, and DB2 are trademarks of International Business Machines Corporation registered in many jurisdictions worldwide).

Virtualization layer 62 provides an abstraction layer from which the following examples of virtual entities may be provided: virtual servers; virtual storage; virtual networks, including virtual private networks; virtual applications and operating systems; and virtual clients.

In one example, management layer 64 may provide the functions described below. Resource provisioning provides dynamic procurement of computing resources and other resources that are utilized to perform tasks within the cloud computing environment. Metering and Pricing provide cost tracking as resources are utilized within the cloud computing environment, and billing or invoicing for consumption of these resources. In one example, these resources may comprise application software licenses. Security provides identity verification for cloud consumers and tasks, as well as protection for data and other resources. User portal provides access to the cloud computing environment for consumers and system administrators. Service level management provides cloud computing resource allocation and management such that required service levels are met. Service Level Agreement (SLA) planning and fulfillment provides pre-arrangement for, and procurement of, cloud computing resources for which a future requirement is anticipated in accordance with an SLA.

Workloads layer 66 provides examples of functionality for which the cloud computing environment may be utilized. Examples of workloads and functions which may be provided from this layer include: mapping and navigation; software development and lifecycle management; virtual classroom education delivery; and automated adaptation of employee compensation values to analytical models (as described more particularly below).

In one aspect, a service provider may perform process steps of the invention on a subscription, advertising, and/or fee basis. That is, a service provider could offer to integrate computer readable program code into the computer system/server 12 to enable the computer system/server 12 to perform process steps of the invention. The service provider can create, maintain, and support, etc., a computer infrastructure, such as the computer system 12, bus 18, or parts thereof, to perform the process steps of the invention for one or more customers. In return, the service provider can receive payment from the customer(s) under a subscription and/or fee agreement and/or the service provider can receive payment from the sale of advertising content to one or more third parties. Services may include one or more of: (1) installing program code on a computing device, such as the computer device 12, from a tangible computer readable medium device 34; (2) adding one or more computing devices to the computer infrastructure 10; and (3) incorporating and/or modifying one or more existing systems 12 of the computer infrastructure 10 to enable the computer infrastructure 10 to perform process steps of the invention.

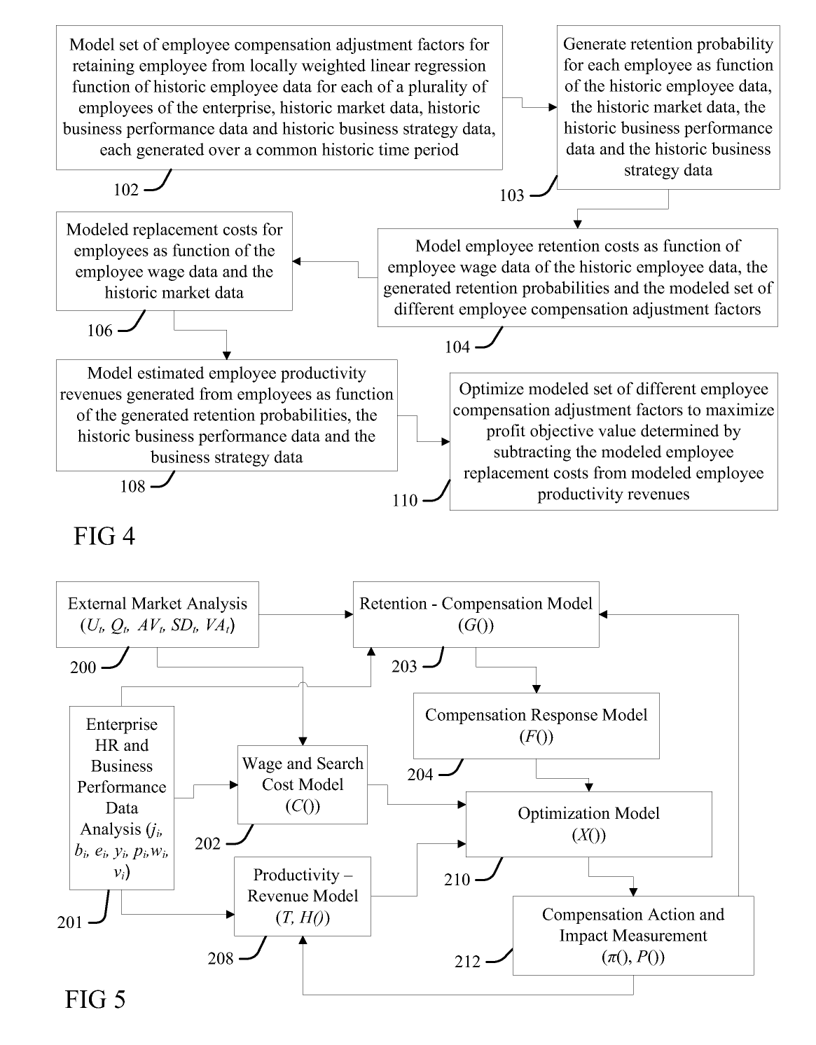

FIG. 4 illustrates a method or process of an aspect of the present invention for automated adaptation of employee compensation values to analytical models. At 102 a set of a plurality of different employee compensation adjustment factors are modeled, for retaining employees of an enterprise, from a locally weighted linear regression function of historic employee data that is generated over a historic time period for each of a plurality of employees of the enterprise, and as a function of historic market data, historic business performance data and historic business strategy data that are generated over the common historic time period.

At 103 a retention probability is generated for each enterprise employee, with respect to the enterprise retaining the employee, as a function of the historic employee data, the historic market data, the historic business performance data and the historic business strategy data, thus relative to the same, common historic time period.

At 104 retention costs are modeled, for adjusting the wages of the plurality of employees to retain the employees, as a function of employee wage data of the historic employee data, the generated retention probabilities, and the modeled set of different employee compensation adjustment factors.

At 106 costs are modeled for replacing employees (“replacement costs”) as a function of the employee wage data and the historic market data.

At 108 estimated employee productivity revenues generated from retaining employees are modeled as a function of the generated retention probabilities, the historic business performance data and the business strategy data.

At 110 the modeled set of different employee compensation adjustment factors are iteratively optimized to maximize a profit objective value determined by subtracting the modeled costs for replacing employees from the modeled employee productivity revenues.

The aspect of FIG. 4 is an analytics-based, highly agile and adaptive business process that is responsive to aspirational revenue targets (the business strategy data), estimating cost of workforce management (operations data of the historic business performance) as a function of the selection and execution of workforce management actions: Human Resources (HR) and operations data of the historic business performance that include hiring, training, performance management and awards data that are input via one streamlined process at a global scale.

Aspects are described herein with respect to employee compensation adjustment and associated actions, but other aspects may be generalized to and implemented within other workforce management actions.

Aspects may measure and model responses for process effectiveness or objectives, and provide decision support systems that enable automated adaptation of underlying analytical models. Aspects may provide actionable insights to business managers for achieving process and business objectives via modeling dynamic relationships between compensation, external labor market data and retention; between retention and hiring and productivity, and between productivity and revenue. Optimizing the compensation factors enables the models to adapt strategies to evolving market conditions. Aspects support execution of desirable compensation actions and continuous monitoring of associated employee responses, enabling “what if?” analysis for business managers in order to select desirable operating points.

FIG. 5 is a flow chart illustration of one implementation of the process, system or method of FIG. 4. The set of different employee compensation adjustment factors (CO) are modeled (at 102, FIG. 4) by a Wage and Search Cost analytics Model 202, from External Market Analysis 200 and Enterprise HR and Business Performance Data 201 inputs. Said Enterprise HR and Business Performance Data 201 inputs include a total number (N) of the individual enterprise employees (i) and components of the historic business performance data for the historic time period (for example, 3-5 years, though any time period may be practiced) for each employee that includes the wage of each employee (wᵢ) and one or more of:

performance rating of each employee (pᵢ);

years of services of each employee (yᵢ);

overall experience of employee (eᵢ);

expertise of employee (bᵢ);

career growth index of employee (jᵢ); and

attrition flag of employee (nᵢ).

Enterprise HR and Business Performance Data 201 also includes business revenue (Mₜ) achieved over the historic time period (t), the business strategy data input includes target business revenue (Tₜ) over said historic time period.

The External Market Analysis 200 inputs include data generated by an analysis of historic external market data for the historic time period, and includes one or more of unemployment rate (Uₜ), quarterly gross domestic product (GDP) of a relevant geographic region (Qₜ), average market wage by job category (AVₜ), standard deviation of market wage by job category (SDₜ), and average voluntary attrition rates by job category (VAₜ).

Thus, a set (C) of allowed employee compensation adjustment factors (x₁, x₂, x₃ . . . x_{N}) for an employee of the enterprise (which may include a value of zero, signifying no adjustment) is generated as an output by the Wage and Search Cost analytics Model 202. One illustrative but non-limiting examples of the compensation adjustment factors is (x₁=3%; x₂=10%; x₃=7%; x₄=0% . . . ; x_{N}=5%), and still others will be apparent to one skilled in the art.

A Retention-Compensation Model 203 performs retention-compensation modeling to generate the employee retention probabilities (Gᵢ) for each enterprise employee (i) (at 103, FIG. 4) from External Market Analysis 200 and Enterprise HR and Business Performance Data 201 inputs. In one aspect the retention probability is generated by expression [1]:

Gᵢ=exp(Zᵢ)/(1+exp(Zᵢ)) [1];

wherein Zᵢ is obtained by a locally weighted linear regression on “(wᵢ−AVₜ)/SDₜ)” and (jᵢ, bᵢ, eᵢ, yᵢ, pᵢ, Uₜ, Qₜ, VAₜ).

The retention probability thus generated is valid for the given time period (t), and is recomputed (at 102, FIG. 4) as compensation is adjusted, which accounts for changes in market conditions over time to account for market volatility in compensation levels.

A Compensation Response Model 204 models employee retention costs (at 104, FIG. 4) as a function of the employee wage and compensation adjustment factors (F(wᵢ, xᵢ)), which relates compensation actions to their impact on retention. Aspects learn the modeled employee retention costs over time through compensation actions and repetitive measurements of its impact. In one example the function F is initialized to (F_0), and defined as a function of the retention probability according to the following expression [2]:

F_0(wᵢ, xᵢ)=G(wᵢ*(1+0.01*xᵢ))−G(wᵢ) [2];

The model is continuously adapted using the impact measured from repetitive actions; at given time period (n) according to the following expression [3]:

Fⁿ⁺¹(w, x)=λ*Fⁿ(w, x)+(1−λ)*(Gⁿ⁺¹(w(1+0.01*x))−Gⁿ(w)) [3]

wherein (λ) is a rate of learning parameter selected from the set of (0, 1).

The Wage and Search Cost Model 202 also models a search cost (S) for replacing employees (at 106, FIG. 4), which may be defined as a function of the employee wage data (wᵢ) and the historic market data unemployment rate (Uₜ), quarterly GDP of the relevant geographic region (Qₜ), average market wage by job category (AVₜ), standard deviation of market wage by job category (SDₜ), and average voluntary attrition rates by job category (VAₜ) (“S=f(wᵢ, Uₜ, Qₜ, AVₜ, SDₜ, VAₜ)”).

In some aspects the search cost (S) is determined through linear regression models on said historic performance, attrition and new hire data, wherein cost per unit of attritted employee is composed of ramp down costs (loss of productive labor hours post employee resignation) and ramp up costs (hours required of a productive employee before a new employee can start to work at its full potential. The search cost may contemplate time lost during labor market search for the employee, using the historic market data and the wage data of new hires, and additional salaries to be paid to backfill for the average tenure of an employee.

A Productivity-Revenue Model 208 models (estimates) relationship (H) between employee productivity, achieved revenues, and the revenue targets. Highly productive employee maps to a revenue achievement that is above target whereas under productive employee maps to under achievement of target revenue. The productivity revenue model (H) (at 108, FIG. 4) generated by retained employees (γ) and from new hires (β) as a function of the generated retention probabilities, the historic business performance data business revenue (Mₜ), the business strategy data target business revenue (Tₜ), and employee performance (pᵢ) data. The mapping H( ) yields the expected revenue given current level of employee productivity and the target revenue.

In some aspects the model 208 is responsive to the productivity value of an employee (π) that is generated by a Compensation Action and Impact Measurement Model 212 from an optimized set (X) of the employee compensation adjustment factors output of an Optimization Model 210 (discussed below). The productivity value (π) may be measured against the pre-defined target business revenue (Tₜ) in order to select a value of employee performance (pᵢ) data from a predefined scale, such as from an integer set (1, 2, . . . , 5), wherein one represents a most productive employee, one who exceeds the target by more than a specified percentage or some other metric. As the performance ratings and hence the productivity levels update in response to said compensation action, an employee productivity value (π) may be defined as depending on said employee performance ratings (pᵢ), by expression [4]:

πᵢ=f(Mₜ, Tₜ, pᵢ) [4].

An Optimization Model 210 optimizes the set (C) of employee compensation adjustment factors (at 110, FIG. 4) to generate an optimized set (X) of the employee compensation adjustment factors to maximize a profit objective value (P) determined by the Compensation Action and Impact Measurement Model, both of which are fed back to the Retention-Compensation Model 203 in order to iteratively generate revised sets (C) of employee compensation adjustment factors (at 110, FIG. 4) and subsequently re-optimized sets (X) (at 110, FIG. 4) in an iterative learning model process.

In one aspect of the present invention an employee retention cost (R) is defined by the Retention-Compensation Model 203 as a function of the products of the optimized set (X) employee compensation adjustment factors (generated as feedback from the Optimization Model 210) and the employee wages according to expression [5]:

R(X)=sum[i](xi*wᵢ) [5].

A target expected retention of the employees (ρ) is defined by expression [6]:

ρ(X)=1/N sum[i](Gᵢ+F(wᵢ, xᵢ)). [6]

Expected hiring of employees (α) is defined by expression [7]:

α(X)=N*(1−ρ(X)). [7]

Expected revenue from new hires (β) is defined as a function of a uniform distribution for productivity (π) and the employee productivity revenues (H) generated by Productivity-Revenue Model 208 by expression [8]:

β(X)=E(H(π))*N*(1−ρ(X)). [8]

Total expected revenue from retained workers (γ) is defined by expression [9]:

γ(X)=sum[i](Gᵢ+F(wᵢ, xᵢ))*H(πᵢ. [9]

Expected wage cost for employees (θ) is defined by expression [10]:

θ(X)=sum[i](1−Gᵢ−F(wᵢ, xᵢ))*(AV−wᵢ)⁺/(1−ρ₀). [10]

Expected Search cost for new hires (φ) is defined by expression [11]:

φ(X)=(1−ρ(X))*N*(U+D+S). [11]

Accordingly, the values of the optimized set (X) may be obtained to maximize the profit objective value (P) according to following profit function expression [12]:

P(X)=β(X)+γ(X)−θ(X)−φ(X), [12]

subject to β(X)+γ(X)>Target Revenue (Tₜ).

Thus, aspects of the present invention utilize business profitability as a measure for process effectiveness. Implementation is generally enabled by a seamless interconnection between business strategy and HR/business operations. The built analytical models use historic data and define analytical methods that adapt as a function of real-time external local labor market condition measurements and observations, thereby modeling relationships between compensation and retention based on external local labor market conditions.

Increases in vacancies for a particular skill in a local labor market may push up local attrition rates. However, pushing up wages in response may result in weakening of enterprise's competitiveness. Modeling relationships according to the present invention between a workforce management action and its response in terms of retention can establish a more nuanced relationship between compensation action and employee retention, which is also useful in modeling relationships between retention and productivity.

Optimization may be invoked at pre-specified time intervals, or depend on a rate of change of underlying model dynamics. For example, if a performance measure drifts more than a pre-specified range, optimization could be automatically triggered.

Decision support systems may track performances triggered by current actions in real time. For example, in one aspect a manager is shown a screen outlining color coded cluster's (such as skill+country) in a performance measure drift heat map (not shown). On clicking certain indicated zones on the heat map (for example, those colored red in a color GUI display device), a manager may be shown current level of expected performance, as well as the set of new actions that can be taken, and the expected performance of the same. Manager can thereby carry out “what if” analysis and select an operating point accordingly. If a new, selected operating point is different from the old one, an engine executes new compensation actions (for example, adjusting employee wages by the optimized set (X) of factors), and continue with monitoring and model adaptation steps.

The terminology used herein is for describing particular aspects only and is not intended to be limiting of the invention. As used herein, the singular forms “a”, “an” and “the” are intended to include the plural forms as well, unless the context clearly indicates otherwise. It will be further understood that the terms “include” and “including” when used in this specification specify the presence of stated features, integers, steps, operations, elements, and/or components, but do not preclude the presence or addition of one or more other features, integers, steps, operations, elements, components, and/or groups thereof. Certain examples and elements described in the present specification, including in the claims and as illustrated in the figures, may be distinguished or otherwise identified from others by unique adjectives (e.g. a “first” element distinguished from another “second” or “third” of a plurality of elements, a “primary” distinguished from a “secondary” one or “another” item, etc.) Such identifying adjectives are generally used to reduce confusion or uncertainty, and are not to be construed to limit the claims to any specific illustrated element or embodiment, or to imply any precedence, ordering or ranking of any claim elements, limitations or process steps.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method for automated adaptation of employee compensation values to analytical models, the method comprising:
modeling a set of a plurality of different employee compensation adjustment factors from a locally weighted linear regression function of historic employee data that is generated over a historic time period for each of a plurality of employees of an enterprise;
generating retention probabilities for retaining each of the employees as a function of historic employee data, historic market data, historic business performance data and historic business strategy data;
modeling total employee retention costs as a function of employee wage data of the historic employee data, the modeled set of different employee compensation adjustment factors and the generated retention probabilities;
modeling costs for replacing employees as a function of the employee wage data and the historic market data;
modeling employee productivity revenues generated by employees as a function of the generated retention probabilities, the historic business performance data and the business strategy data; and
iteratively optimizing the modeled set of different employee compensation adjustment factors to maximize a profit objective value determined as a function of the modeled costs for replacing employees and the modeled employee productivity revenues.

2. The method of claim 1, further comprising:
integrating computer readable program code into a computer readable storage medium; and
wherein a processor that is in circuit communication with a computer readable memory and the computer readable storage medium executes instructions of the program code integrated on the computer readable storage medium via the computer readable memory and thereby performs the steps of modeling the set of employee compensation adjustment factors, generating the retention probabilities for retaining each of the employees, modeling the total employee retention costs, modeling the costs for replacing employees, modeling the employee productivity revenues generated by the employees, and iteratively optimizing the modeled set of different employee compensation adjustment factors.

3. The method of claim 1, wherein the step of modeling the set of employee compensation adjustment factors from the locally weighted linear regression function of historic employee data is response to an input of wages of each of plurality of employee, performance ratings of each employee, and at least one of years of services of each employee, overall experience of employee, expertise of employee, career growth index of employee and an attrition flag of employee.

4. The method of claim 3, further comprising:
modeling the total employee retention cost as a function of a total of products of selected ones of the optimized modeled set of employee compensation adjustment factors and input wages of each of the employees.

5. The method of claim 4, wherein the step of modeling the total employee retention cost comprises learning the total employee retention cost as a function (F( )) of the generated employee retention probabilities (G) over a given time period (n) according to:
Fⁿ⁺¹(w, x)=λ*Fⁿ(w, x)+(1−λ)*(Gⁿ⁺¹(w(1+0.01*x))−Gⁿ(w))
wherein (λ) is a rate of learning parameter selected from a set of (0, 1).

6. The method of claim 4, further comprising:
determining a target expected retention rate of the employees (ρ) as a function of the iteratively optimized modeled set of different employee compensation adjustment factors (X) according to:
ρ(X)=1/N sum[i](Gᵢ+F(wᵢ, xᵢ));
wherein (i) indicates each of the employees, and (wᵢ, xᵢ) indicates the selected ones of the optimized modeled set of employee compensation adjustment factors and input wages of each of the employees; and
wherein the step of modeling the employee productivity revenues generated by employees is a function of the determined target expected retention rate of the employees (ρ).

7. The method of claim 6, further comprising:
estimating productivity revenues generated by retained employees (γ), and productivity revenues generated from new hires (β), as a function of the generated retention probabilities, the historic business performance data business revenue (Mₜ) for the historic time period (t), the business strategy data target business revenue (Tₜ) for the historic time period (t), and the performance ratings of each employee (pᵢ);
wherein the step of modeling employee productivity revenues generated by employees is further a function of the estimated productivity revenues generated by retained employees (γ) and the estimated productivity revenues generated from new hires (β).

8. The method of claim 7, wherein the step of iteratively optimizing the modeled set of employee compensation adjustment factors to maximize the profit objective value comprises defining the profit objective value as a sum of the estimated productivity revenues generated by retained employees (γ) and the estimated productivity revenues generated from new hires (β), less expected search costs for new hires and less expected wage costs;
subject to the sum of the estimated productivity revenues generated by retained employees (γ) and the estimated productivity revenues generated from new hires (β) being greater than the business strategy data target business revenue (Tₜ) for the historic time period (t).

9. A system, comprising:
a processor;
a computer readable memory in circuit communication with the processor; and
a computer readable storage medium in circuit communication with the processor;
wherein the processor executes program instructions stored on the computer readable storage medium via the computer readable memory and thereby:
models a set of a plurality of different employee compensation adjustment factors from a locally weighted linear regression function of historic employee data that is generated over a historic time period for each of a plurality of employees of an enterprise;
generates retention probabilities for retaining each of the employees as a function of historic employee data, historic market data, historic business performance data and historic business strategy data;
models total employee retention costs as a function of employee wage data of the historic employee data, the modeled set of different employee compensation adjustment factors and the generated retention probabilities;
models costs for replacing employees as a function of the employee wage data and the historic market data;
models employee productivity revenues generated by employees as a function of the generated retention probabilities, the historic business performance data and the business strategy data; and
iteratively optimizes the modeled set of different employee compensation adjustment factors to maximize a profit objective value determined as a function of the modeled costs for replacing employees and the modeled employee productivity revenues.

10. The system of claim 9, wherein the processor executes the program instructions stored on the computer readable storage medium via the computer readable memory and thereby further:
models the set of employee compensation adjustment factors from the locally weighted linear regression function of historic employee data in response to an input of wages of each of plurality of employee, performance ratings of each employee, and at least one of years of services of each employee, overall experience of employee, expertise of employee, career growth index of employee and an attrition flag of employee.

11. The system of claim 10, wherein the processor executes the program instructions stored on the computer readable storage medium via the computer readable memory and thereby further:
determines the total employee retention cost as a function of a total of products of selected ones of the optimized modeled set of employee compensation adjustment factors and input wages of each of the employees.

12. The system of claim 10, wherein the processor executes the program instructions stored on the computer readable storage medium via the computer readable memory and thereby further models the total employee retention cost as a function of a total of products of selected ones of the optimized modeled set of employee compensation adjustment factors and input wages of each of the employees.:

13. The system of claim 12, wherein the processor executes the program instructions stored on the computer readable storage medium via the computer readable memory and thereby further models the total employee retention cost by learning the total employee retention cost as a function (F( )) of the generated employee retention probabilities (G) over a given time period (n) according to:
ρ(X)=1/N sum[i](Gᵢ+F(wᵢ, xᵢ));
wherein (λ) is a rate of learning parameter selected from a set of (0, 1).

14. The system of claim 12, wherein the processor executes the program instructions stored on the computer readable storage medium via the computer readable memory and thereby further:
determines a target expected retention rate of the employees (ρ) as a function of the iteratively optimized modeled set of different employee compensation adjustment factors (X) according to:
ρ(X)=1/N sum[i](Gᵢ+F(wᵢ, xᵢ));
wherein (i) indicates each of the employees, and (wᵢ, xᵢ) indicates the selected ones of the optimized modeled set of employee compensation adjustment factors and input wages of each of the employees; and
models the employee productivity revenues generated by employees as a function of the determined target expected retention rate of the employees (ρ).

15. A computer program product for automated adaptation of employee compensation values to analytical models, the computer program product comprising:
a computer readable storage medium having computer readable program code embodied therewith, the computer readable program code comprising instructions for execution by a processor that cause the processor to:
modeling a set of a plurality of different employee compensation adjustment factors from a locally weighted linear regression function of historic employee data that is generated over a historic time period for each of a plurality of employees of an enterprise;
generate retention probabilities for retaining each of the employees as a function of historic employee data, historic market data, historic business performance data and historic business strategy data;
model total employee retention costs as a function of employee wage data of the historic employee data, the modeled set of different employee compensation adjustment factors and the generated retention probabilities;
model costs for replacing employees as a function of the employee wage data and the historic market data;
model employee productivity revenues generated by employees as a function of the generated retention probabilities, the historic business performance data and the business strategy data; and
iteratively optimize the modeled set of different employee compensation adjustment factors to maximize a profit objective value determined as a function of the modeled costs for replacing employees and the modeled employee productivity revenues.

16. The computer program product of claim 15, wherein the computer readable program code instructions for execution by the processor further cause the processor to model the set of employee compensation adjustment factors from the locally weighted linear regression function of historic employee data in response to an input of wages of each of plurality of employee, performance ratings of each employee, and at least one of years of services of each employee, overall experience of employee, expertise of employee, career growth index of employee and an attrition flag of employee.

17. The computer program product of claim 16, wherein the computer readable program code instructions for execution by the processor further cause the processor to determine the total employee retention cost as a function of a total of products of selected ones of the optimized modeled set of employee compensation adjustment factors and input wages of each of the employees.

18. The computer program product of claim 16, wherein the computer readable program code instructions for execution by the processor further cause the processor to model the total employee retention cost as a function of a total of products of selected ones of the optimized modeled set of employee compensation adjustment factors and input wages of each of the employees.

19. The computer program product of claim 18, wherein the computer readable program code instructions for execution by the processor further cause the processor to model the total employee retention cost by learning the total employee retention cost as a function (F( )) of the generated employee retention probabilities (G) over a given time period (n) according to:
Fⁿ⁺¹(w, x)=λ*Fⁿ(w, x)+(1−λ)*(Gⁿ⁺¹(w(1+0.01*x))−Gⁿ(w));
wherein (λ) is a rate of learning parameter selected from a set of (0, 1).

20. The computer program product of claim 18, wherein the computer readable program code instructions for execution by the processor further cause the processor to:
determine a target expected retention rate of the employees (ρ) as a function of the iteratively optimized modeled set of different employee compensation adjustment factors (X) according to:
ρ(X)=1/N sum[i](Gᵢ+F(wᵢ, xᵢ));
wherein (i) indicates each of the employees, and (wᵢ, xᵢ) indicates the selected ones of the optimized modeled set of employee compensation adjustment factors and input wages of each of the employees; and
model the employee productivity revenues generated by employees as a function of the determined target expected retention rate of the employees (ρ).
